(19) United States
(12) Patent Application Publication
(10) Pub. No.: US 2005/0054388 A1
(43) Pub. Date: Mar. 10, 2005

(54) Method of automatic mobile call forwarding

(76) Inventors: Zhihong Dong, Duluth, GA (US); Qunli Wu, San Diego, CA (US); Yi Sun, Duluth, GA (US); Jian Song, San Diego, CA (US)

Correspondence Address: Michael Zhihong Deng;Apt. 3324, 1435 Boggs Rd., Duluth, GA, 30096, US

(21) Appl. No.: 10/914,476

(22) Filed: Aug. 9, 2004

Related U.S. Application Data
(60) Provisional application No. 60/493,699, filed on Aug. 8, 2003.

(51) Int. Cl. H04B 1/38

(52) U.S. Cl. 455/573; 455/566; 455/417; 455/557

(57) ABSTRACT

A communication system includes a Mobile Switching Center (103), a wireless terminal (a cell phone) (102), a wire-line terminal (a corded telephone) (105) and a battery-charging unit (101) for the cell phone. A call forwarding feature from the wireless cell phone to the wire-line telephone is automatically activated and set up when the wireless cell phone is placed on to the battery-charging unit. The call forwarding feature is automatically deactivated and cancelled when the cell phone is removed from the battery-charging unit.

### TECHNICAL FIELD

This invention relates to wireless and wire line telecommunications, and more particularly, to a method and system for automatically initiating a call forwarding feature associated with a subscriber's mobile wireless phone so that calls are automatically forwarded to the subscriber's home or office telephone line from the subscriber's wireless mobile phone.

### BACKGROUND OF THE INVENTION

Call forwarding is a feature usually available through telecommunication carriers (wire line or wireless) that enables a subscriber to automatically have the phone calls forwarded to another phone number. In its basic implementation, a subscriber dials a feature code from the telephone associated with the subscribed-to service and inputs the forwarding phone number to which he wants subsequent calls diverted (forwarded). The central office switch recognizes the feature code and the telephone line from which the subscriber has dialed, and the central office switch there after redirects calls from the subscriber's phone to the forwarding phone number. For automatic call forwarding, the call forwarding feature is activated (set up) or deactivated (cancelled) by the action of the subscriber to place or remove the phone from the battery-charging unit. When the wireless phone is placed on the charging unit, a signal is created and sent to the MCU. The MCU then connects with the wireless phone and sends it the call forwarding feature code which contains the forwarding wire line phone number programmed by the subscriber in the charging unit in advance. Then the wireless phone dials the call forwarding feature code to the Mobile Switch Center to set up the call forwarding service. When the wireless phone is removed from the charging unit, a signal is created and sent to the MCU. The MCU then connects with the wireless phone and sends it the call forwarding feature cancellation code. Then the wireless phone dials the call forwarding feature cancellation code to the Mobile Switch Center to cancel the call forwarding service.

### SUMMARY OF THE INVENTION

The object is achieved in that a call is automatically diverted/forwarded from the wireless mobile phone to the wire-line telephone once a wireless mobile phone has been placed on a dedicated charging unit. This provides the user the convenience to pick up phone calls from the corded phone set wherever the incoming calls either to the mobile phone or the wire-line telephone. For further convenience, this invention can make the activation and deactivation automatically after the initial setup of the charging unit. When the user want to leave and take the mobile phone along, a push button or switch is touched and the pre-programmed charging unit can start the deactivation process. Then the call forwarding function will be canceled and the incoming calls to the mobile phone or the wire-line telephone will go to either destination respectively.

In an embodiment of the invention the charging unit comprises means for receiving detector signals generated because the mobile phone has been placed onto or taken away from the charging and data interface, and means for converting the signals to activate or deactivate the call forwarding.

In another embodiment of the invention, the microprocessor used in the charging unit will start to run a pre-stored program when it senses the detector signal. The program will read from the memory in the charging unit that stores the wire-line telephone number by the user during the initiation setup. The program will send AT modem commands to the mobile phone through the charging and data interface. The AT commands sent to the mobile switch contains special character string defined by the service carrier that can activate or deactivate call forwarding function to a mobile phone.

It will be appreciated that the call forwarding automation system includes logic and memory for storing call forwarding telephone numbers, selecting a number based upon user's choice besides the function of a charging unit, and automatically activating or deactivating call forwarding to the mobile phone by the action of placing on or taking away from the charging unit.

According to a second preferred embodiment of the present invention, the charging unit can prompt the user for status of call forwarding on and off and charging progress through its screen. It is very convenient to let the user to input call forwarding numbers and/or read battery charging information. Even a phone book can be stored and displayed provided the memory size is enough.

The above and other objects, features, advantages and aspects of the present invention will become apparent upon reading and understanding the present specification, from and elucidated with reference to the embodiments described hereinafter, and when taken in conjunction with accompanying drawings.

### BRIEF DESCRIPTION OF THE DRAWINGS

The accompanying drawings incorporated in as forming a part of the specification, illustrate several aspects of the present invention, and together with the description serve to explain the principles of the invention. In the drawings:

FIG. 1 shows a diagram representation of a communication system according to the invention.

### DETAILED DESCRIPTION OF THE PREFERRED EMBODIMENT

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

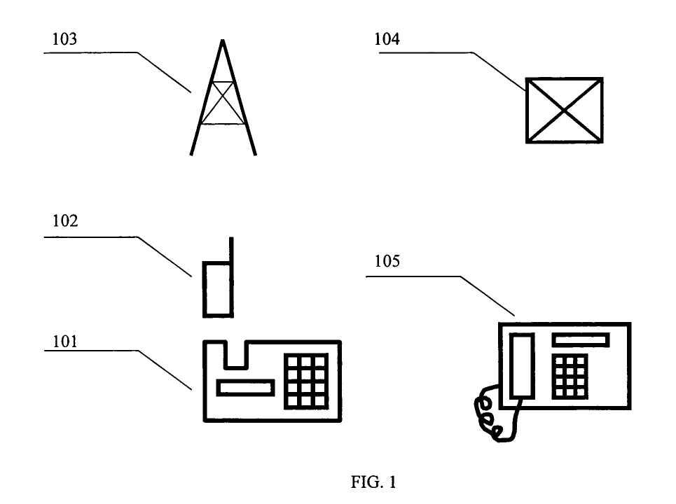

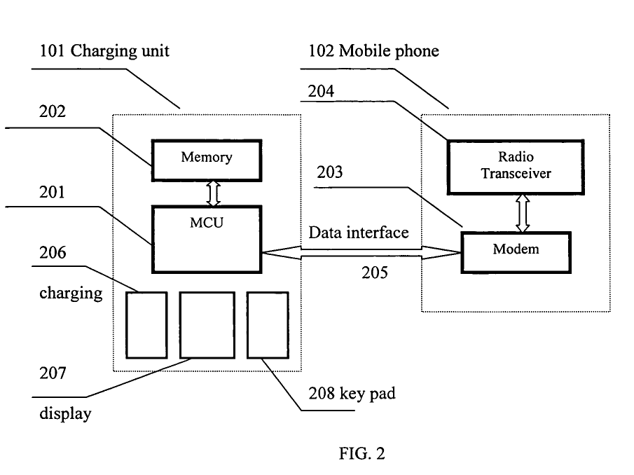

Referring now in greater detail to the drawings in which numerals represent like components throughout the several views. The communication system shown in FIG. 1 comprises a mobile switch 104 to which is connected a base station 103. The mobile phone 102 can be placed onto or taken away from the charging unit 101. The wire-line telephone 105 is a POTS (Plain Old Telephone Set) in office or home of the user. The diagram applies to a variety of wireless telephones of various embodiments of the present invention, as well as various types of wireless telephones, including but not limited to analog, digital or multimode cellular phones, PCS, GSM, CDMA and 3G wireless phones etc.

To illustrate the operation of this system by way of example, suppose a user can activate or deactivate call forwarding of the mobile phone 102 manually by input a special command string and a forwarding telephone number on the key pad of the mobile phone, then the string can be sent by the internal modem 203 of the mobile phone through air interface (radio path) 204 and received by base station 103. The base station 103 will pass the command to the mobile switch 104. The command will be processed and executed by mobile switch 104 to activate the call forwarding. The deactivation procedure is the same vice versa except the respective deactivation command is input and no need of forwarding number.

Having described the basic operation of manual call forwarding, reference is now made to FIG. 1 and FIG. 2 to describe the preferred embodiment of the present invention. In this regard, the present invention is directed to an apparatus for performing a call forwarding operation automatically. Specifically, the invention performs a call forward operation that forwards, or re-directs, calls destined for a mobile phone to an alternative number, such as a wire-line telephone. In accordance with the preferred embodiment, the present invention provides a user-programmable manner, which the user can conveniently input, read, modify and select the forwarding number among a plurality of numbers stored in memory 202 on the charging unit 101. The call forwarding operation starts automatically when a user places the mobile phone 102 on the charging unit 101. The call forwarding operation starts automatically when a button or a switch on the charging unit is pushed before the mobile phone 102 is taken away from the charging unit 101.

More specifically, one aspect of the preferred embodiment of the present invention is directed to a charging unit 101 for a mobile phone 102. In operation, the call forward feature is activated and deactivated automatically. Upon placing a mobile phone 102 on the charging unit 101, the call forwarding feature of the present invention is automatically carried out. In this regard, detection circuitry within the charging unit 101 senses when the mobile phone 102 is placed onto the charging unit 101, to automatically invoke the call forwarding procedure which is pre-programmed and run by the microprocessor 201 of the charging unit 101. As will be appreciated by those skilled in the art, the call forwarding feature is carried out by sending a message from the mobile phone 102 to base station 103, then is passed to the mobile switch 104. This message instructs the mobile switch 104 that any and all incoming calls that are directed to the mobile phone 102 are to be rerouted to another phone number, as specified by the call forwarding number. Before taking away the mobile phone 102 from the charging unit 101, the deactivation procedure of call forwarding feature of the presentation invention is started by touching a button or a switch on the charging unit 101. Another message will be sent from the mobile phone 102 to base station 103 then passed to the mobile switch 104. The message instructs the mobile switch 104 to cancel any call forwarding previously set.

In accordance with another aspect of the present invention, the improved charging unit 101 includes means for specifying one of a plurality of call forwarding numbers. The user can input and modify multiple numbers anytime and can select any number stored in the memory as the call forwarding number. The advantages to re-direct calls to a common number are not limited to provide convenience and efficiency when a user arrives an office or home with a wire-line telephone, but calls rerouted to the wire-line telephone are generally much cheaper, since the user will not be required to pay for air time of calls otherwise received from the mobile phone. The wire-line telephone also provides better voice quality because of no radio wave dispersion, signal fading and noise. The mobile phone 102 can save its battery life or be charged on the charging unit 101. This can assure the user has a mobile phone 102 with as full battery life as possible whenever the mobile phone 102 is in use.

To achieve the advantages and novel features, the present invention is generally directed to an improved charging unit 101 and mobile phone 102 providing call forwarding. In accordance with one aspect of the invention, a charging unit 101 for a mobile phone 102 is provided having means for connection to an electrical power source and a charging circuitry 206. The charging unit 101 further includes a data interface 205 compliant with the mobile phone 102, microprocessor 201 and memory 202. Finally, the charging unit 101 includes a keypad 208 for input and a screen 207 for information display.

In accordance with another aspect of the invention, the wire-line telephone number can be input through the keypad 208 on the charging unit 101 and stored in an assigned address of the memory subsystem 202. The number input by the user is displayed on the screen 207 when the keypad 208 is pushed during the initiation setup or could be read from the memory 202 and displayed on the screen 207 after the initiation, either.

In accordance with yet another aspect of the invention, a method is provided for instructing a cellular telephone network to forward calls otherwise directed to a mobile phone 102. When the microprocessor 201 senses a detector signal for placing a mobile phone 102 onto the charging unit 101, a pre-programmed activation routine will be called and starts to run. The routine will read the pre-stored wire-line telephone number from the assigned address and initiated serial link setup with the mobile phone 102 through the data interface 205 in the mean time. After the handshaking finished, a set of AT commands will be sent through the data interface 205 to the mobile phone 102 and then sent to the mobile switch 104 through air interface 204 and base station 103. The AT commands contains special strings defined by the service carrier so that can activate the mobile phone call forwarding to the pre-set wire-line telephone number. When the microprocessor 201 senses a detector signal for taking away a mobile phone 102 from the charging unit 101, another routine will be called and starts to run. The deactivation routine will not read the pre-stored telephone number but just sends out AT commands containing special strings for deactivation to the mobile switch 104. Then the call forwarding will be cancelled.

While the embodiments of the present invention, which has been disclosed herein, are the preferred forms, other embodiments of the method and apparatus of the present invention will suggest themselves to persons skilled in the art in view of this disclosure. Therefore, it will be understood that variations and modifications can be effected within the spirit and scope of the invention and that the scope of the present invention should only be limited by the claims below. Furthermore, the corresponding structures, materials, acts, and equivalents of any means-or step-plus-function elements in the claims below are hereby described to include any structure, material, or acts for performing the claimed functions in combination with other claimed elements as specifically claimed.

1. A charging unit for a mobile phone comprising:
means for connection to data interface to the mobile phone; a key pad; a screen; a microprocessor; a memory subsystem.

2. The charging unit as defined in claim 1, wherein the call forwarding numbers can be input, modified and displayed through the keypad and the screen.

3. The charging unit as defined in claim 1, wherein the data interface includes power lines and serial port (e.g. RS-232, USB etc.).

4. The charging unit as defined in claim 1, wherein the deactivation trigger mechanism can be a push button or a switch.
